(19) United States
(12) Patent Application Publication
(10) Pub. No.: US 2012/0224356 A1
(43) Pub. Date: Sep. 6, 2012

(54) ILLUMINATED PROTECTIVE HARD HAT

(76) Inventors: TROY FISCHER, Gig Harbor, WA (US); DONALD QUNELL, Bonney Lake, WA (US)

(21) Appl. No.: 13/410,289

(22) Filed: Mar. 1, 2012

Related U.S. Application Data
(60) Provisional application No. 61/447,946, filed on Mar. 1, 2011.

(51) Int. Cl. F21V 21/084

(52) U.S. Cl. 362/106

(57) ABSTRACT

An illuminated protective hard hat includes at least one work light and plurality of safety lights. The hat provides a hands-free illumination. The safety lights are set to flashing for higher visibility in dangerous work zones. This illuminated protective hard hat can be used by anyone working in a construction zone, such as flaggers or road workers. It can also be utilized by miners, utility personnel, or anyone else working in dimly lit or dark environments. The hat is worn like a standard hard hat but has a power switch connected to a power source to selectively turn on or turn of the safety lights and the work light.

### CROSS-REFERENCE TO RELATED APPLICATION

This application claims the benefit of Provisional Patent Application No. 61/447,946, filed on Mar. 1, 2011, in the United States Patent & Trademark Office, the disclosure of which is incorporated herein by reference.

### BACKGROUND OF THE INVENTION

1. Field of the Invention

The present invention relates generally to a protective hard hat and in particular to an illuminated protective hard hat having integrally molded one or more battery powered adjustable light sources.

2. Background

Individuals working at a roadside construction zone, especially at night, or working inside a tunnel, are at an increased risk of being hit by passing motorists. A conventional hard hat does not allow an individual to be visible in their work area. This is also true for miners and other individuals working in dimly lit conditions. Additionally, workers often need a light source when working in the dark. It can be difficult and inconvenient to hold a flash light or other type of light while working.

Conventionally helmets, such as those worn by miners, have been equipped with lamps; these lamps are generally mounted upon the front of the helmet with the beam being directed only in forward direction limiting the safety of the wearer, thus there is a chance of being hit by passing motorists. Also in these types of helmets, holding the bulky lamp in the fixed position is difficult and time consuming. With other limitations, the lamp consumes more power and is more expensive in long run.

### DESCRIPTION OF THE PRIOR ART

Numerous innovations for hard hats have been provided in the prior art as described below. Even though these innovations may be suitable for the specific individual purposes to which they address, however, they differ from the present invention.

A FIRST EXAMPLE, U.S. Patent Office Document No. 5,810,467, issued on Sep. 22, 1998, to Hurwitz, teaches an illuminated protective hat comprising a protective hat shell having a power unit portion formed thereon and at least one electroluminescent lamp secured to the protective hat shell. The power unit portion being provided to supply power to the at least one electroluminescent lamp and further the power unit portion comprises contacts for connection to a recharging unit.

A SECOND EXAMPLE, U.S. Patent Office Document No. 5,915,539, issued on Jun. 19, 1999, to Lack, teaches a hard hat, comprising a rigid shell having colored indicators on the hard hat to visually communicate to others that their safety is also being considered. Red, for example, is the basic color for marking dangerous locations and the presence of flammable fluids. On the other hand, yellow is the basic color for designating caution and the presence of striking, falling or tripping hazards. Finally, green is the basic color for designating a safe environment. When an employee selectively displays one of these colors with a hard hat constructed in accordance with the present invention, the employee indicates to others that a task may pose dangers for which appropriate precautions are required by all nearby observers.

A THIRD EXAMPLE, U.S. Patent Office Document No. 3,749,902, issued on Jul. 31, 1973, to Drew et al, teaches a hard hat, comprising first white light sources disposed in a manner so that light is directed downwardly upon the user. A second flash light source may be operatively mounted on top of the hat and provided with a red lens for indicating “danger.” The light source on top of the hard hat may be supported by means of a tubular bolt member extending to a base portion of the light source through an aperture formed in an upper surface of the head gear. The conductors extending between that light source and the source of electromotive power may be extended through the cylindrical space defined by the tubular bolt.

A FOURTH EXAMPLE, U.S. Patent Office Document No. 6,461,015, issued on Oct. 8, 2002, to Welch, teaches a hard hat, comprising a flashing light source mounted to rotate or fixed to the top of the hat. The light provided shines out throughout a full 360 degree circle around the wearer to signal and warn people of the presence of the wearer or of danger.

It is apparent now that numerous innovations for illuminated protective hard hat have been provided in the prior art that are adequate for various purposes. Furthermore, even though these innovations may be suitable for the specific individual purposes to which they address, accordingly, they would not be suitable for the purposes of the present invention as heretofore described. Thus a safer, more efficient hard hat option is needed.

### SUMMARY OF THE INVENTION

The present invention of illuminated protective hard hat provides a hands-free illuminated hat having a position adjustable work light molded into the front of the hard hat. It also includes flashing safety lights for higher visibility in dangerous work zones. This illuminated protective hard hat can be used by anyone working in a construction zone, such as flaggers or road workers. It can also be utilized by miners, utility personnel, or anyone else working in dimly lit or dark environments. The hat has a hard shell made from molded plastic having plurality of integrally molded housings to mount a power source, the work light and the safety lights. The hat includes an adjustable nylon head liner and is worn like a standard hard hat but has a power switch connected to a power source to selectively turn on or turn of the safety lights and the work light.

It is an object of the invention to provide an illuminated protective hard hat comprising a hard shell with plurality of integrally molded housings in the hard shell for securely mounting light sources in the housings.

It is another object of the invention is to provide at least a position adjustable work light integrated into the integrally molded housing at front of the hat, wherein the housing has provisions to position the work light in desired angled position.

It is still another object of the invention is to mount a safety light integrated with the work light in the housing at front of the hat.

It is still further another object of the invention is to provide at least one flashing safety light integrated into the integrally molded housings at left and right sides of the hat.

It is still yet another object of the invention is to provide at least one power source integrated into the integrally molded housing in the hard shell of the hat.

It is still another object of the invention is to provide a power switch connected to the power source to selectively turn on or turn off the work light and the safety lights.

It is still further another object of the invention is to use very low heat emitting and energy efficient light sources such as light emitting diode (LED) as work light and safety lights.

It is still yet another object of the invention is to provide integrally molded wiring channels on the hat to connect the light sources with the power source while minimizing the exposure of the wiring and connection to environment or moisture thereby increasing longevity of the wiring and the connection while improving the decorum of the protective hard hat.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

The figures of the drawings are briefly described as follows:

FIG. 1 is a top perspective view showing the present invention;

FIG. 2 is a side perspective view of the present invention;

FIG. 3a is a top sectional view of the present invention;

FIG. 3b is side sectional view of the present invention;

FIG. 4 is block diagram showing connectivity between the power source and lights and electrical arrangement of the present invention; and

FIG. 5 is a circuit diagram of electrical connections of the present invention.

### REFERENCE NUMERALS UTILIZED IN THE DRAWINGS

100 illuminated protective hard hat
102 hard shell
   103 brim of the hat 100
104 front housing
105 slopped top wall of the front housing 104
106 right side housing
108 left side housing
110 work light mounted in the front housing 104
112 safety light mounted in the right side housing 106
114 safety light mounted in the left side housing a side sectional view of the hat 100
116 safety light mounted in the front housing 104
118 guide ways for adjustable head liner
120 integrally molded wiring channel connecting the front housing 104
122 integrally molded wiring channel connecting the channel
120 and right side housing 106
124 integrally molded wiring channel connecting the channel
120 and left side housing 108
126 power switch on the front housing 104
128 power source mounted in the front housing 104
130 light controller unit connected to the power switch 126
132 light sensor
134 blink chip

### DETAILED DESCRIPTION OF THE PREFERRED EMBODIMENT

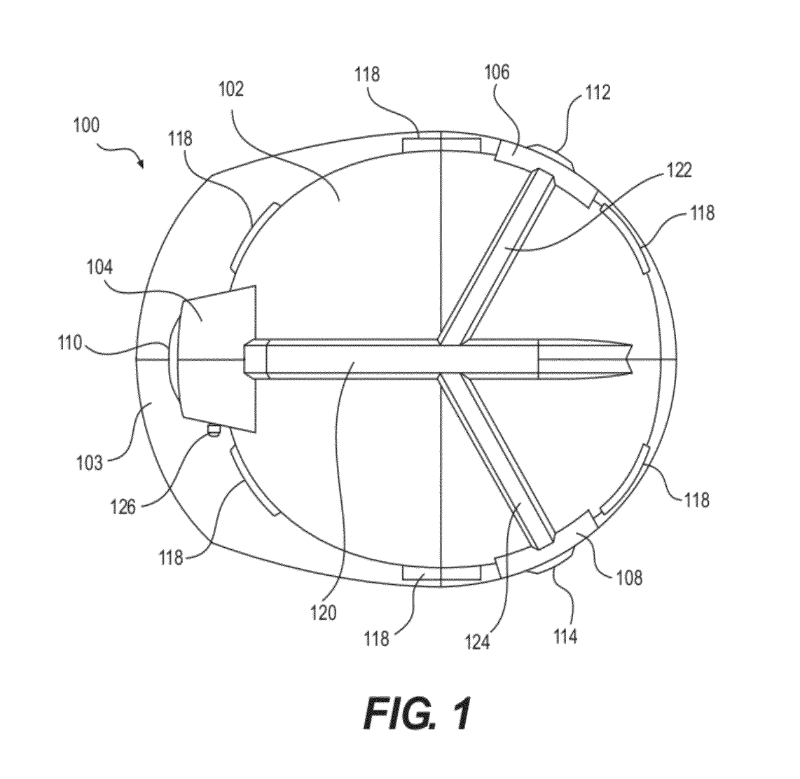

Referring now in more detail to the drawings, in which like numerals indicate like parts throughout the views, FIG. 1 illustrates top perspective view of an illuminated protective hard hat 100 having a hard shell 102 made from molded plastic, wherein the hard shell 102 has a front, left side, right side, back and a top portion. The hard shell 102 further comprises plurality of integrally molded housings (104, 106, and 108) to securely mount safety/emergency light sources (110, 112, and 114) within the housings (104, 106, and 108). The light sources used in the present invention are LEDs (light emitting diodes). LED consumes less power while having high intensity and emits very less heat while being light weight and less bulky, thus is best suitable for illuminating the protective hard hat 100. The hat 100 also has a brim portion 103 at the front side in order to provide additional protection to the user, the brim 103 can be designed suitably so as not to act as a hindrance in the path of the work light 110. The brim 103 provides bottom wall support for the integrally molded front housing 104.

Furthermore, as shown in FIG. 1, an adjustable work light 110 integrated into a front housing 104, wherein the front housing 104 is integrally molded in the front part of the hat 100 and has provisions to position the work light 110 in desired angled position to focus on the work area. The work light 110 is a continuously glowing white LED. Plurality of bright or high luminescent white LEDs may be used as the work light, so as to sufficiently illuminate the work area.

At least one safety light 114 (as shown in FIG. 1) is integrated into left side housing 108, wherein the housing 108 is integrally molded at left side of the hat 100 and at least one safety light 112 is integrated into right side housing 106, wherein the housing 106 is integrally molded at the right side of the hat 100. The safety/emergency lights are flashing red LEDs. The flashing light blinks at a regular time interval e.g. every 0.5-2 seconds so as to provide alert signals for higher visibility in dangerous work zones. However continuous glowing safety lights with several other color LEDs can be used without departing from the scope and spirit of the invention.

The hard hat 100 further comprises integrally molded guide ways 118 for securing an adjustable nylon head liner. The head liner is provided with provisions at both ends for adjusting the length of the liner as per the need of the user.

Furthermore, a plurality of integrally molded wiring channels (120, 122, and 124) running on the top of the hat 100 so as to provide a closed channel for wiring and establishing connection between the power source with the work light 110 and the safety lights (112, 114, and 116). The integrally molded wiring channel 120 connects the front housing 104 and the other integrally molded wiring channels 122 and 124. The integrally molded wiring channels 122 connects the channel 120 and right side housing 106 and the integrally molded wiring channel 124 connects the channel 120 and left side housing 108. The wiring inside the channels (120, 122, and 124) is intended to prevent the wiring and the connections from moisture or other climatic conditions while beautifying the hat 100.

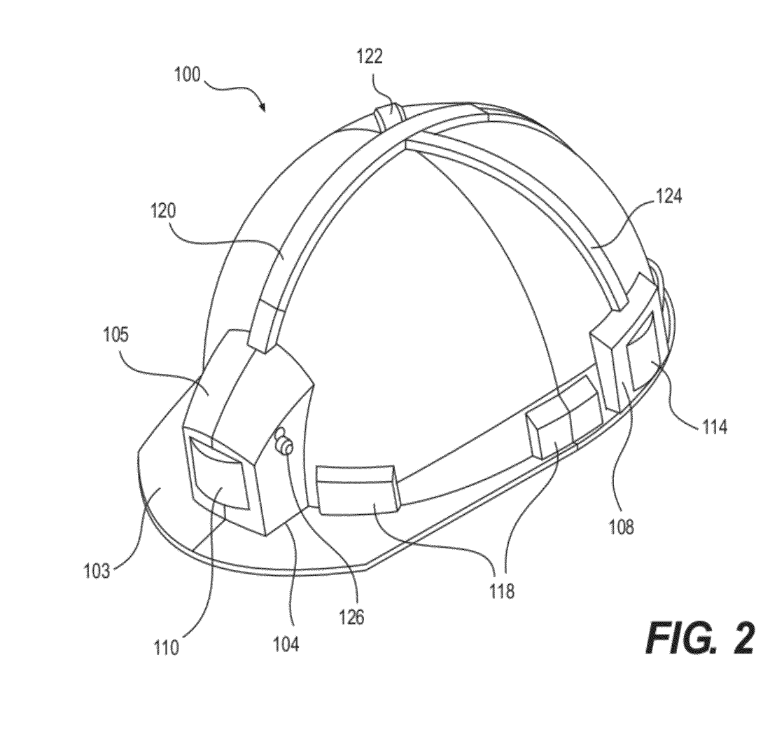

As shown in FIG. 2, the top wall 105 of the front housing 104 is slopped in a downward direction, so as to minimize the impact force on the user when debris or other hazardous objects collides the top wall 105 of the front housing 104. Moreover, the top wall of the side housings (106 and 108) can also be slopped to minimize impact force of the colliding objects. The slopped top wall also helps in reducing water or dust retaining on the top surface.

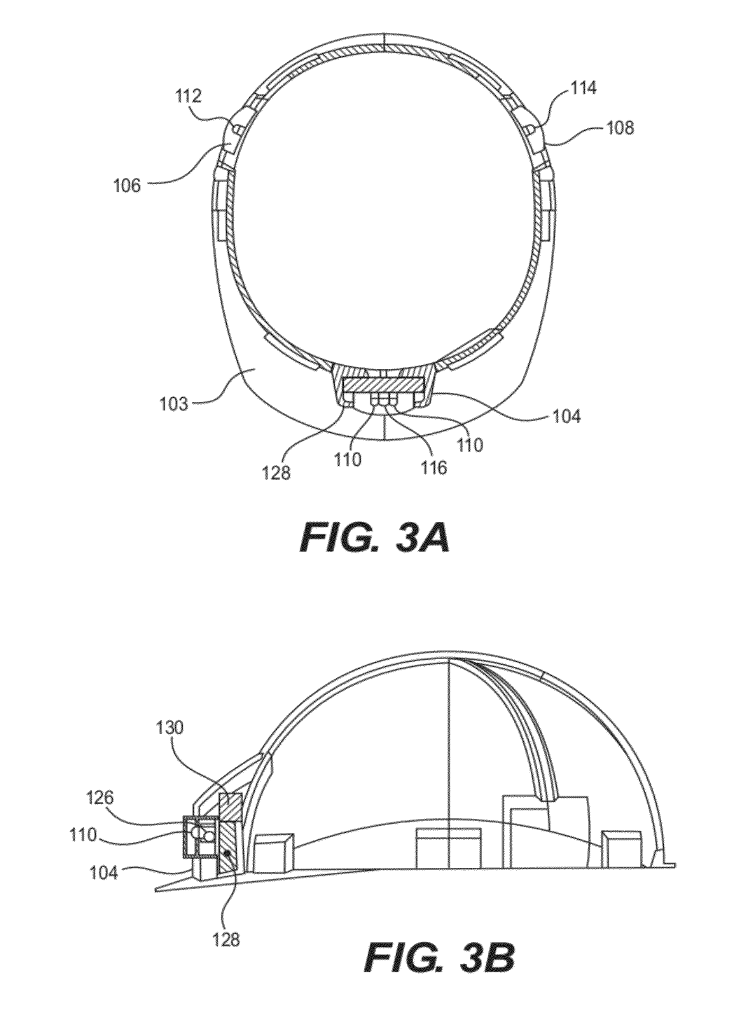

As shown in FIG. 3a (a top sectional view of the hat 100): another safety/emergency light 116 is integrated with the work light 110 in the front housing 104. The safety light 116 is a flashing red LED. The safety/emergency light 116 having low intensity in comparison to the intensity of the work light 110 and the flashing frequency is controlled so as to minimize interference with the continuous glowing work light 110. The flashing light blinks at a regular time interval e.g. every 0.5-2 seconds so as to provide alert signals for higher visibility in dangerous work zones. However, continuous glowing safety lights with several other color LEDs can be used without departing from the scope of the invention.

Furthermore, one power source 128 (as shown in FIG. 3a) is integrated into the front housing 104. The power source 128 is a 4.5 DC volt rechargeable battery; however other type and rated power sources can be used so as to illuminate the light sources (110, 112, 114 and 116). The front housing 104 further comprises a power switch 126 which is connected to the power source 128 to selectively turn on or turn off the work light 110 and the safety/emergency lights (112, 114, and 116). The power switch 126 is a multi state toggle switch, wherein pressing the switch 126 for a first depression turns on the work light 110, a second depression of the switch 126 turns off the work light 110 and activates the safety lights, a third depression of the switch 126 turns on both the work light 110 and the safety lights (112, 114, and 116) and a fourth depression of the power switch 126 turns off both the work light 110 and the safety lights (112, 114, and 116). In another example, the toggle switch 126 runs on plurality of modes such as,

in mode1: safety lights (112, 114, and 116) blink,
in mode2: work light 110 is turned on,
in mode3: work light 110 is on and safety lights (112, 114, and 116) blink, and
in mode4 both work light 110 and safety lights (112, 114, and 116) are turned off.

However other modification and combinations to control the safety lights and the work light can be practiced without departing from the scope and spirit of the invention.

As shown in FIG. 3b (a side sectional view of the hat 100), the arrangement of the power source 128, power switch 126, a light controller unit 130 and the work light 110 in the front housing 104 is shown.

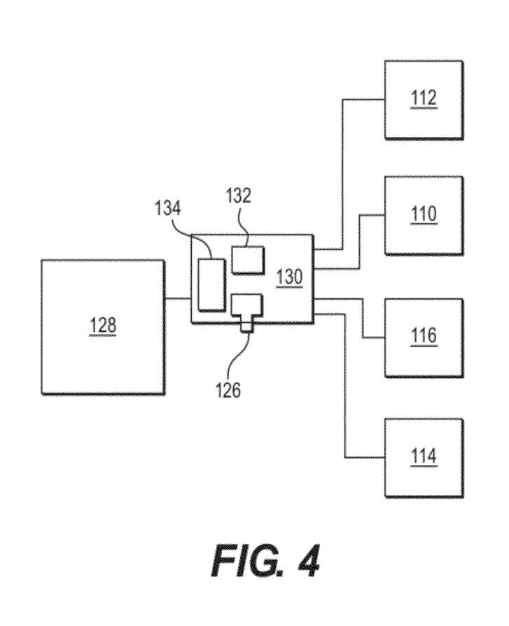

FIG. 4 illustrates a block diagram of the connection between the power source 128 and the light sources (110, 112, 114 and 116) via the light controller unit 130. The light controller unit 130 comprises a light sensor 132, a blink chip 134 and a power switch 126. The light sensor senses the safety lights (112, 114, and 116) signal and activate the blink chip to flash the safety lights (112, 114, and 116) at a regular time interval.

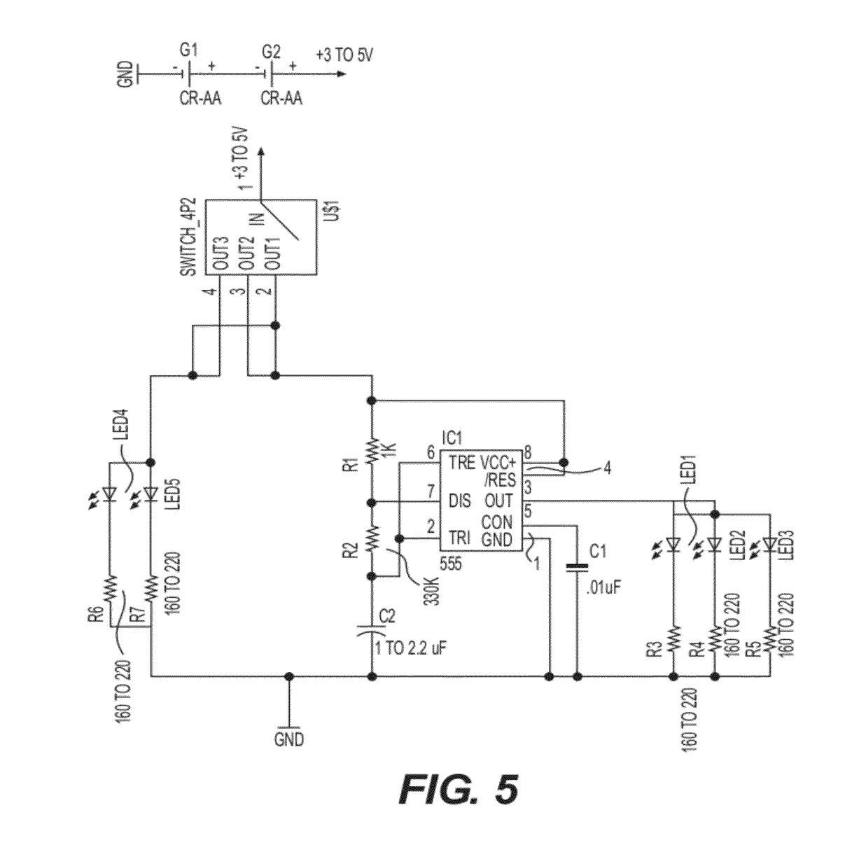

FIG. 5 illustrates a circuit diagram of the blink chip 134. The blink chip 134 used in the present invention is a 555 timer circuit. The 555 timer chip is connected to resistors R1, R2, R3, R4, R5, R6, R7 (each is from 160-200 ohms), capacitors C1 (0.01 uF), C2 (1 to 2.2 uF), safety/emergency lights LED1, LED2, LED3, AND work lights (LED4+LED5) and toggle switch _{—}4P2.

Other such timing circuits can also be efficiently used to control the lights of the hard hat 100 without departing from the scope and spirit of the invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

The invention claimed is:

1. An illuminated protective hard hat for a worker comprising:
an adjustable work light integrated into a front housing, wherein the front housing is integrally molded at the front part of the hat and has provisions to position the work light in desired angled position;
a safety/emergency light is integrated with the work light in the front housing;
two safety/emergency lights are integrated into each side housings, wherein the side housings are integrally molded at left and right sides of the hat;
a one power source integrated into the front housing, wherein a power switch mounted in the front housing is connected to the power source to allow the worker to selectively turn on or turn off the work light and the safety lights in four depression toggling modes; and
a plurality of integrally molded wiring channels on the hat allowing electrical connection between the front housing and the side housings.

2. The illuminated protective hard hat of claim 1, wherein the work light is at least one continuously glowing white LED.

3. The illuminated protective hard hat of claim 1, wherein the safety/emergengy light is at least one flashing red LED with blinking rate is about 0.5-2.0 seconds controlled by a timing 555 timer circuitry.

4. The illuminated protective hard hat of claim 1, wherein the four depression toggling modes includes: a first depression of the power switch turns on the work light, a second depression turns off the work light and activates safety lights, a third depression of the power switch turns on both the work light and the safety lights and a fourth depression of the power switch turns off both the work light and the safety lights.

5. The illuminated protective hard hat of claim 1, wherein the wiring channel connects the front housing with the side housings.

6. An illuminated protective hard hat for a worker comprising:
at least one safety light integrated into each side housings molded at left and right sides of the hat; wherein an independent power source and a power switch integrated into each of the side housings to independently turn on or turn off the safety lights in four depression toggling modes;
an adjustable work light integrated into a front housing, wherein the front housing is integrally molded in the front part of the hat and the front housing further comprises a power source and a power switch to independently turn on or turn off the work light; and
a safety/emergency light integrated with the work light in the front housing, wherein the safety light in the front housing is connected with the power source in the front housing with an independent power switch to independently turn on or turn off the safety light in said four depression toggling modes.

7. The illuminated protective hard hat of claim 6, wherein the work light is at least one continuously glowing white LED.

8. The illuminated protective hard hat of claim 6, wherein the safety light is at least one flashing red LED with blinking rate is about 0.5-2.0 seconds controlled by a timing 555 timer circuitry.

9. The illuminated protective hard hat of claim 6, wherein the front housing has provisions to adjust the position of the work light in a desired angled position.
